(19) United States
(12) Patent Application Publication
(10) Pub. No.: US 2026/0105278 A1
(43) Pub. Date: Apr. 16, 2026

(54) MAPPING A LARGE LANGUAGE MODEL (LLM) TO A SYSTEM ARCHITECTURE USING ARTIFICIAL INTELLIGENCE

(71) Applicant: NVIDIA Corporation, Santa Clara, CA (US)

(72) Inventors: Shvetank Prakash, Boston, MA (US); Robert Hesse, Santa Clara, CA (US); Qijing Huang, Mountain View, CA (US); Christoforos Kozyrakis, Palo Alto, CA (US); Vikram Sharma Mailthody, Urbana, IL (US); Dheevatsa Mudigere, Fremont, CA (US); Angshuman Parashar, Northborough, MA (US); Sanjay Patel, Urbana, IL (US)

(21) Appl. No.: 19/255,571

(22) Filed: Jun. 30, 2025

Related U.S. Application Data
(60) Provisional application No. 63/707,690, filed on Oct. 15, 2024.

(51) Int. Cl. G06N 3/04

(52) U.S. Cl. CPC G06N 3/04

(57) ABSTRACT

Mappings are used to parallelize and schedule large language models (LLMs) onto a target system architecture. Given the complexity of the LLM and the system architecture, there can be from tens of thousands to trillions of potential mappings, each offering varying levels of performance and energy efficiency. Identifying an optimal (or near-optimal) mapping is essential for maximizing the performance of LLM workloads. The present disclosure employs artificial intelligence to map a LLM to a system architecture, where the mapping can be determined from a combined representation of properties of the LLM and system architecture generated by a machine learning model.

### RELATED APPLICATION(S)

This application claims the benefit of U.S. Provisional Application No. 63/707,690 (Attorney Docket No. NVIDP1424+/24-BO-1392US01), titled “RANKING SOFTWARE MAPPINGS OF A TENSOR ALGORITHM USING LEARNED SIMILARITY AND SHARED REPRESENTATION SPACES” and filed Oct. 15, 2024, the entire contents of which is incorporated herein by reference.

### TECHNICAL FIELD

The present disclosure relates to processes for mapping large language models to hardware for execution.

### BACKGROUND

Mappings are used to parallelize and schedule large language models (LLMs) onto a target system architecture such as a data center with accelerator devices or an edge device platform such as a robotics system. Given the complexity of the LLM and the system architecture, there can be from tens of thousands to trillions of potential mappings, each offering varying levels of performance and energy efficiency. Identifying an optimal (or near-optimal) mapping is essential for maximizing the performance of LLM workloads.

A simple approach is to perform an exhaustive search, but this simple approach is impractical given the substantial number of potential mappings. Thus, most prior works have used heuristics and human-expert-guided techniques to narrow down the mapping space. However, these methods are still either infeasible to execute in real-time and/or may not fully optimize performance of the LLM.

There is thus a need for addressing these issues and/or other issues associated with the prior art. For example, as described in the embodiments below, it is possible to address these issues by employing artificial intelligence to map a LLM to a system architecture, where the mapping can be determined from a combined representation of properties of the LLM and system architecture generated by a machine learning model.

### SUMMARY

A method, computer readable medium, and system are disclosed to map a machine learning model to a system architecture. In an embodiment, a combined representation of properties of a machine learning model and properties of a system architecture is generated by another machine learning model. The combined representation is processed to determine one of a plurality of mappings to use to map the machine learning model to the system architecture.

In another embodiment, a combined representation of properties of a machine learning model and properties of a system architecture is generated by another machine learning model. The combined representation is processed, by a generative machine learning model, to generate a mapping to use to map the machine learning model to the system architecture.

### BRIEF DESCRIPTION OF THE DRAWINGS

FIG. 1 illustrates a method for using a machine learning model for determining one of a plurality of mappings to use to map a LLM to a system architecture, in accordance with an embodiment.

FIG. 2 illustrates a pipeline for training a machine learning model to generate a combined representation of properties of an LLM and a system architecture which can then be processed to determine one of a plurality of mappings to use to map a LLM to a system architecture, in accordance with an embodiment.

FIG. 3 illustrates a pipeline for ranking a set of mappings that map a LLM to a system architecture, in accordance with an embodiment.

FIG. 4 illustrates a method for using a generative machine learning model for generating a mapping to use to map a LLM to a system architecture, in accordance with an embodiment.

FIG. 5 illustrates a system for using artificial intelligence to map a LLM to a system architecture, in accordance with an embodiment.

FIGS. 6A-C illustrates exemplary parallelization schemes by which a LLM can be parallelized on a system architecture, in accordance with an embodiment.

FIG. 7A illustrates inference and/or training logic, according to at least one embodiment.

FIG. 7B illustrates inference and/or training logic, according to at least one embodiment.

FIG. 8 illustrates training and deployment of a neural network, according to at least one embodiment.

FIG. 9 illustrates an example data center system, according to at least one embodiment.

### DETAILED DESCRIPTION

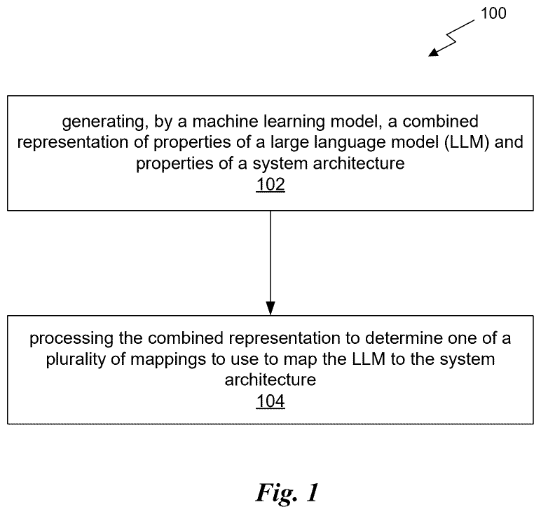

FIG. 1 illustrates a method 100 for using a machine learning model for determining one of a plurality of mappings to use to map a LLM to a system architecture, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, a combined representation of properties of a LLM and properties of a system architecture is generated by a machine learning model. The LLM refers to a machine learning model configured to perform one or more language processing tasks. The properties of the LLM refer to one or more configurations of the LLM. The properties may be defined in software (i.e. code of the LLM). For example, the properties of the LLM may include one or more of: a sparsity of the LLM, a data type of the LLM, a sequence length of the LLM, a number of layers of the LLM, a number of heads of the LLM, a dimensionality of hidden state vectors within an attention mechanism of the LLM, a dimensionality of a hidden layer within a Feed Forward Network (FFN) of the LLM, or a batch size configured for the LLM.

The system architecture refers to a hardware system configured to execute code. In embodiments, the system architecture may be a data center, an edge device, a high-performance computing (HPC) cluster (e.g. DGXH100 or NVL72), an artificial intelligence computing cluster (e.g. clusters of DGX H100, GB200 NVL72, etc.), etc. In an embodiment, the system architecture may include a plurality of processors (e.g. graphics processing units (GPUs)) over which the LLM is capable of being parallelized.

The properties of the system architecture refer to one or more configurations of the system architecture. The properties may be defined in hardware (i.e. hardware of the system architecture). For example, the properties of the system architecture may include one or more of: a central processing unit (CPU) type included in the system architecture, a non-GPU accelerator included in the system architecture, a graphics processing unit (GPU) type included in the system architecture, a number of GPUs included in the system architecture, a number of processing units of the non-GPU accelerator, GPU, CPU, etc., a topology of the system architecture, a communication network type included in the system architecture, or an interconnect fabric type included in the system architecture.

As mentioned, a combined representation of the properties of a LLM and the properties of a system architecture is generated by a machine learning model in operation 102. The combined representation refers to a single data representation for both the properties of a LLM and the properties of a system architecture. In an embodiment, the combined representation may be a single embedding of the properties of the LLM and the properties of the system architecture learned by the machine learning model. In an embodiment, the combined representation of the properties of the LLM and the properties of the system architecture may be generated by concatenating the properties of the LLM and the properties of the system architecture, and learning by the machine learning model an embedding of the concatenated properties of the LLM and properties of the system architecture.

In operation 104, the combined representation is processed to determine one of a plurality of mappings to use to map the LLM to the system architecture. In an embodiment, the one of the plurality of mappings to use to map the LLM to the system architecture may be determined as a result of its embedded representation being most closely aligned with the combined representation of the properties of the LLM and the properties of the system architecture, as determined in accordance with a predefined metric (e.g. cosine similarity that is to be maximized or Euclidean distance that is to be minimized). In an embodiment, the one of the plurality of mappings to use to map the LLM to the system architecture may be an optimal or near optimal or some defined threshold (e.g. 70%) of optimal mapping to use to map the LLM to the system architecture among the plurality of mappings, where for example the one of the plurality of mappings to use to map the LLM to the system architecture is the most optimal mapping, or is an optimal or near optimal mapping, among the plurality of mappings in terms of performance (e.g. of the LLM corresponding to system and/or user transactions per second (TPS), time to first token (TTFT), latency, throughput, etc.), energy efficiency (e.g. of the system architecture in terms of performance per watt, etc.), a combination thereof, or any other desired metric.

In an embodiment, the plurality of mappings (from which one is determined or retrieved) may include different possible parallelization schemes by which the LLM can be parallelized on the system architecture. The different possible parallelization schemes may include at least one of: one or more data parallelization schemes or one or more model parallelization schemes. In an embodiment, the plurality of mappings may include different possible scheduling schemes by which the LLM can be executed on the system architecture. In an embodiment, the plurality of mappings may include different possible runtime frameworks for executing the LLM on the system architecture, such as TensorRT-LLM (TRT-LLM), SGLang, vLLM, etc.

In an embodiment, the plurality of mappings may be predetermined (e.g. by an analytics tool) and may include all possible mappings between the LLM and the system architecture. In an embodiment, the plurality of mappings may be predetermined and may include a subset of all possible mappings between the LLM and the system architecture (e.g. as selected based on a predefined criteria input to the model). In an embodiment, each mapping in the plurality of mappings may be embedded in a shared representation space used to generate the combined representation of the properties of the LLM and the properties of the system architecture.

In an embodiment, the one of the plurality of mappings to use to map the LLM to the system architecture may be determined using a predefined metric (e.g. a cosine similarity that is to be maximized or Euclidean distance that is to be minimized with respect to the mapping's embedding and the combined representation embedding which are both in the shared representation space). In an embodiment, processing the combined representation may include generating a list ranking at least a subset of the plurality of mappings in accordance with the predefined metric, where the one of the plurality of mappings to use to map the LLM to the system architecture is determined as a top ranked mapping in the list.

In an embodiment, the one of the plurality of mappings to use to map the LLM to the system architecture may be output to a downstream application. In an embodiment, the downstream application may use the determined mapping to configure the system architecture to execute the LLM. In an embodiment, the downstream application may use the determined mapping to predict a performance of the LLM on the system architecture, to tune the LLM, or for any other downstream task associated with the LLM and/or the system architecture.

While embodiments described herein refer to using the machine learning model to determine a mapping of a LLM to a system architecture, a more general embodiment of the method 100 is contemplated in which a first machine learning model is used to determine a mapping of a second machine learning model to a system architecture. In this generalized embodiment, a combined representation of properties of the second machine learning model and properties of the system architecture is generated by a first machine learning model. The combined representation is processed to determine one of a plurality of mappings to use to map the second machine learning model to the system architecture. The second machine learning model may therefore be the LLM, as described above, or in other embodiments may be another type of attention-based machine learning model, another type of deep neural network (DNN), etc.

To this end, in this generalized embodiment, the method 100 may include the operations 102-104 described above, where the properties of the second machine learning model are specific to a type of the second machine learning model (e.g. sequence length where the second machine learning model is an LLM, number of heads where the second machine learning model is any attention-based machine learning model, a hidden vector size where the second machine learning model is a DNN, etc.). Further, the same or similar mapping features may be used with respect to any type of machine learning model.

Further embodiments will now be provided in the description of the subsequent figures. It should be noted that the embodiments disclosed herein with reference to the method 100 of FIG. 1 may apply to and/or be used in combination with any of the embodiments of the remaining figures below. As mentioned above, any descriptions herein that reference a LLM may equally apply to other types of machine learning models.

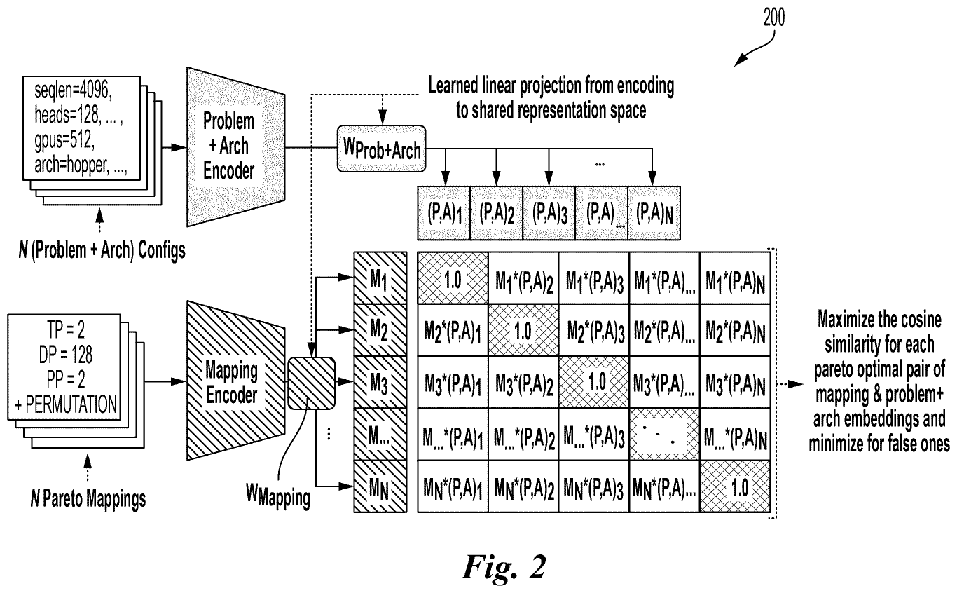

FIG. 2 illustrates a pipeline 200 for training a machine learning model to generate a combined representation of properties of an LLM and a system architecture which can then be processed to determine one of a plurality of mappings to use to map a LLM to a system architecture, in accordance with an embodiment. The pipeline 200 may be implemented to train the machine learning model used in the method 100 of FIG. 1, in an embodiment. Thus, the pipeline 200 may be implemented at training time. The definitions and embodiments provided above may equally apply to the present description.

As shown, training data used for training the machine learning model is comprised of pairs of different LLMs and different system architectures defined by their respective properties (depicted as “N(Problem+Arch) Configs”), as well a plurality of possible mappings for each of the LLM/system architecture pairs (depicted as “N Pareto Mappings”). A first encoder (depicted as “Problem+Arch Encoder”) encodes the LLM/system architecture pairs to form a plurality of first encodings. A second encoder (depicted as “Mapping Encoder”) encodes the possible mappings for each of the LLM/system architecture pairs to form a plurality of second encodings. The first and second encodings are projected to a shared representation space, using a learned linear projection W, to form respective embeddings. The model, namely the combination of the two encoders and the linear projections, is then trained on the learned representations of the LLM/system architecture pairs and the mappings by minimizing the distance (e.g. maximizing the cosine similarity and/or minimizing the Euclidean distance) for each pareto optimal pair of LLM/system architecture and mapping embeddings while maximizing the distance for nonoptimal pairs.

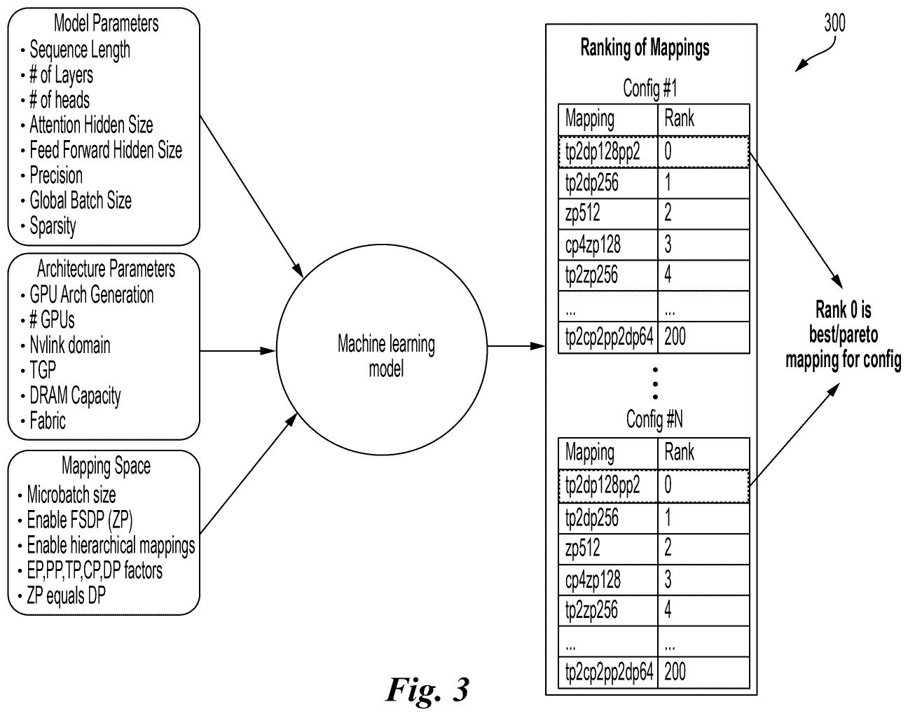

FIG. 3 illustrates a pipeline 300 for ranking a set of mappings that map a LLM to a system architecture, in accordance with an embodiment. The machine learning model described herein may be the model described above with respect to FIG. 1 and/or trained as described with respect to FIG. 2. The pipeline 300 may be implemented at inference time. Again, the definitions and embodiments provided above may equally apply to the present description.

As shown, the machine learning model receives as input properties of an LLM (depicted as “Model Parameters”), properties of a system architecture (depicted as “Architecture Parameters”) and a plurality of possible mappings of the LLM to the system architecture (depicted as “Mapping Space”). The machine learning model processes the input to generate a combined representation of the properties of the LLM and the properties of the system architecture.

The combined representation is then processed to determine which one of a plurality of possible mappings is optimal or near optimal for the LLM/system architecture pair. In the present embodiment, the plurality of possible mappings may be ranked in accordance with a predefine metric, and a top ranked one of the possible mappings may be selected as the mapping that is optimal for the LLM/system architecture pair. The rankings may be based on similarity of the LLM/system architecture pair and mapping, within a shared representation space.

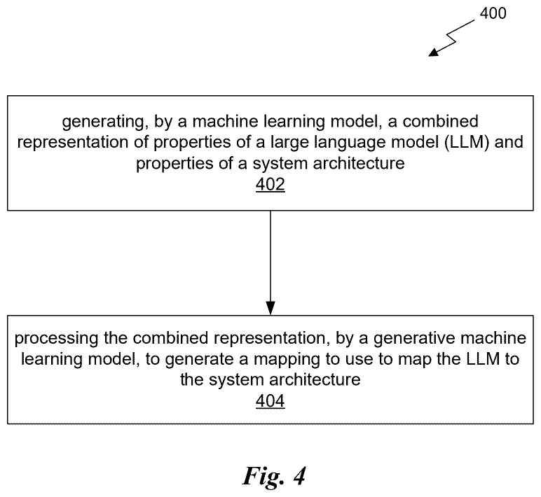

FIG. 4 illustrates a method 400 for using a generative machine learning model for generating a mapping to use to map a LLM to a system architecture, in accordance with an embodiment. The method 400 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 400. In another embodiment, a non-transitory computer-readable media may store computer instructions which when executed by one or more processors of a device cause the device to perform the method 400.

It should be noted that many of the definitions and descriptions provided with respect to FIG. 1 may equally apply to the present method 400 of FIG. 4. In operation 402, a combined representation of properties of a LLM and properties of a system architecture is generated by a machine learning model. The combined representation may be generated as described above with respect to operation 102 of FIG. 1.

In operation 404, the combined representation is processed, by a generative machine learning model, to generate a mapping to use to map the LLM to the system architecture. In an embodiment, the generative machine learning model may be a diffusion model. In an embodiment, the generative machine learning model may be an autoregressive model (i.e. a transformer).

To this end, while the method 100 of FIG. 1 determines one of a plurality of mappings to use to map the LLM to the system architecture, the present method 400 generates the mapping to use to map the LLM to the system architecture (e.g. without selection from among predetermined possible mappings for the LLM/system architecture pair). Given a pre-trained aligned (LLM, mapping, architecture) embedding space, the generative machine learning model may be used to sample the embedding space and directly generate a new mapping.

In an embodiment, the generative machine learning model may be trained to generate a mapping to use to map an LLM and system architecture given properties of the LLM and properties of the system architecture. In an embodiment, the generative machine learning model may be trained to conditionally generate the mapping (i.e. conditioned on the input LLM/system architecture pair) in a latent space. For a diffusion model the mapping is generated via an iterative denoising process.

In an embodiment, the generative machine learning model may be trained using guided generation. At each iteration/step of the denoising process, the mapping will be assessed using the similarity between LLM/system architecture and mappings, which may be learned as described in the embodiments above, to guide the generation in the direction of a mapping that is similar to the embedded LLM/system architecture of interest. Guiding the generation in this manner ensures that the generated mapping is a high-performance mapping for that specific LLM/system architecture pair.

In an embodiment, the generative machine learning model may be trained using conditioned generation. In this embodiment, the obtained embedding of desired LLM/system architecture pair from the aligned embedding space is fed as an input to the diffusion model to conditionally generate the mapping. This then forces the model to map the LLM/system architecture embeddings from the shared representation space to the latent space the generative machine learning model is synthesizing mappings from. Since the pretrained embedding captures the relationships between LLM/system architecture and mappings it may yield better generated mappings.

Similar to the method 100 of FIG. 1, the mapping to use to map the LLM to the system architecture may be output to a downstream application. In an embodiment, the downstream application may use the generated mapping to configure the system architecture to execute the LLM. In an embodiment, the downstream application may use the generated mapping to predict a performance of the LLM on the system architecture, to tune the LLM, or for any other downstream task associated with the LLM and/or the system architecture.

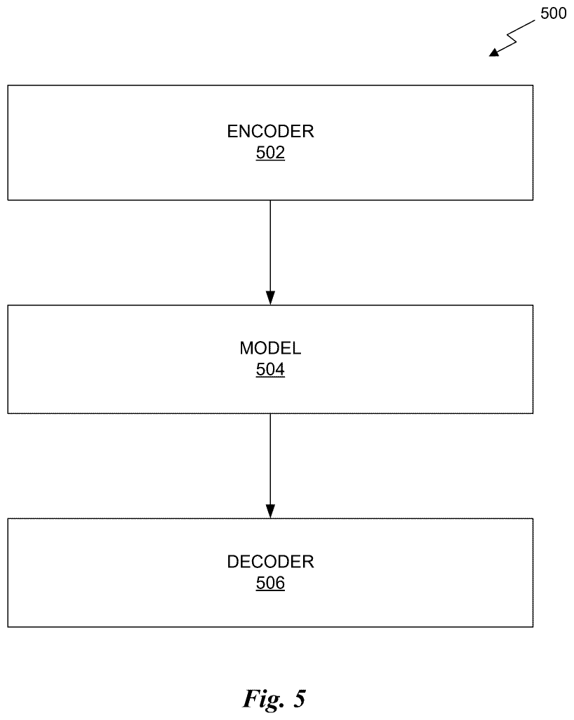

FIG. 5 illustrates a system 500 for using artificial intelligence to map a LLM to a system architecture, in accordance with an embodiment. The system 500 may be implemented in the context of the method 100 of FIG. 1 or the method 400 of FIG. 4. The definitions and embodiments provided above may equally apply to the present description. The components 502-506 of the system 500 may each be implemented in hardware, software, or a combination thereof. The components 502-506 of the system 500 may execute on a same computing device or different computing devices, in various embodiments.

As shown, the system 500 includes an encoder 502 that is configured to encode properties of a LLM and properties of a system architecture. A model 504 is configured to generate (e.g. learn) a combined representation, or embedding, of the LLM and system architecture properties.

A decoder 506 (i.e. diffusion model) processes the combined representation to generate a mapping to use to map the LLM to the system architecture. In an embodiment, parameters of the mapping may be output to a downstream application (not shown), which may or may not be a component of the system 500. In an embodiment, the downstream application may use the parameters of the determined mapping to configure the system architecture to execute the LLM. The system architecture may then execute the LLM, for example upon receipt of an input, to generate inferenced data.

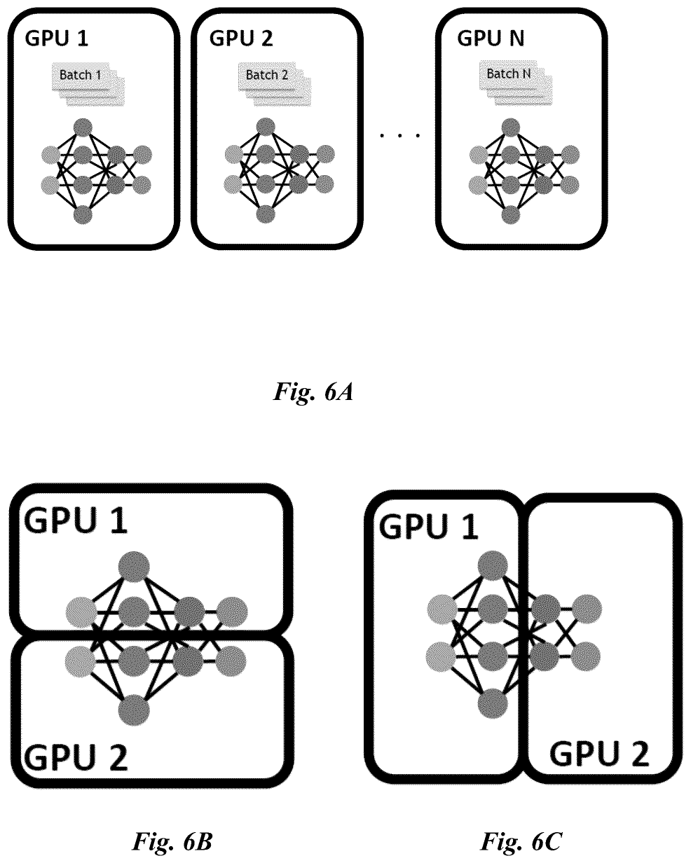

FIGS. 6A-C illustrates exemplary parallelization schemes by which a LLM can be parallelized on a system architecture, in accordance with an embodiment. These parallelization schemes illustrate examples of different mappings for an LLM to a system architecture.

FIG. 6A shows a data parallelization scheme involving weight tensor replication across GPUs, where each GPU then processes respective batches of input data. FIGS. 6B and 6C show model parallelization schemes involving weight tensor sharding across GPUs. In FIG. 6B, tensors are parallelized across the GPUs. In FIG. 6C, pipelines are parallelized across the GPUs. While not shown, it should be noted that additional ways of sharding transformer model tensors may also be used, such as expert parallelism, sequence parallelism, and context parallelism. Another possible parallelization scheme includes fully sharded data parallelism which is a hybrid of data parallelism and model parallelism.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

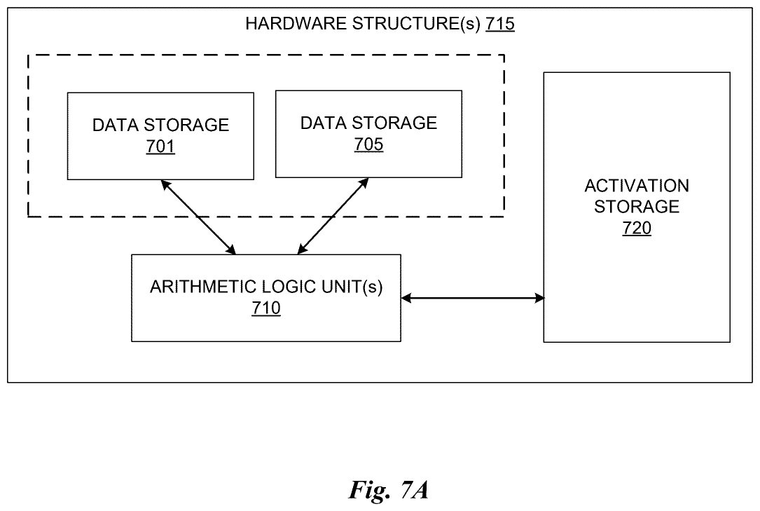

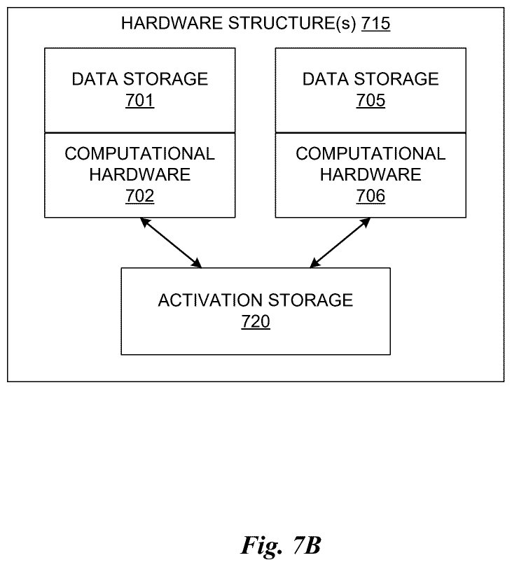

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

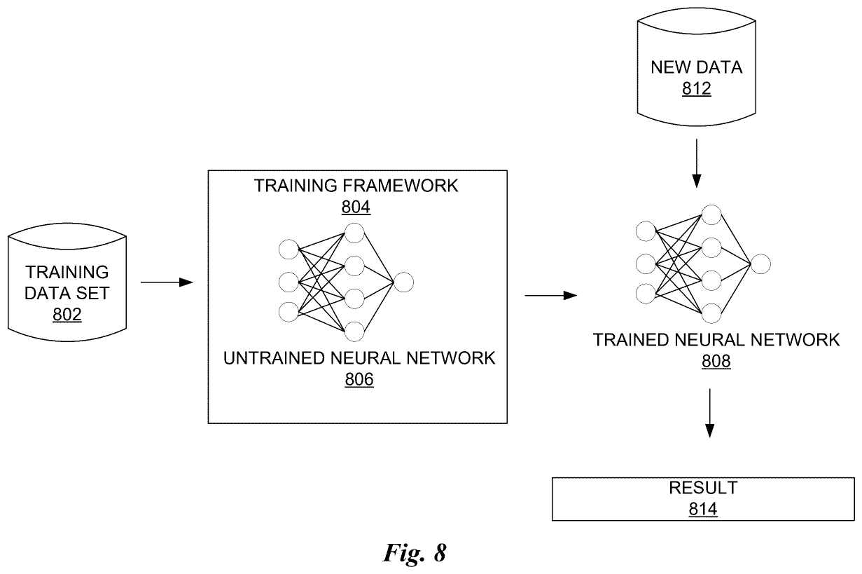

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

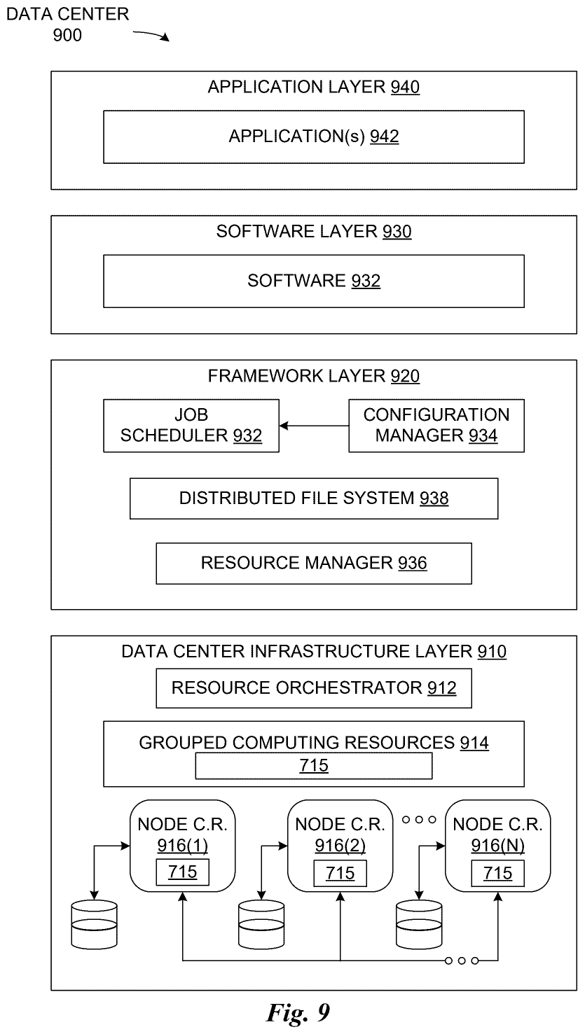

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R. s”) 916(1)-916(N), where “N” represents any whole, positive integer. In at least one embodiment, node C.R. s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R. s from among node C.R. s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed for using a machine learning model, optionally along with a generative machine learning model, to map an LLM to a system architecture. In accordance with FIGS. 1-6, embodiments may provide such models usable for performing inferencing operations and for providing inferenced data. The models may be stored (partially or wholly) in one or both of data storage 701 and 705 in inference and/or training logic 715 as depicted in FIGS. 7A and 7B. Training and deployment of the models may be performed as depicted in FIG. 8 and described herein. Distribution of the models may be performed using one or more servers in a data center 900 as depicted in FIG. 9 and described herein.

What is claimed is:

1. A method, comprising:
at a device:
generating, by a first machine learning model, a combined representation of properties of a second machine learning model and properties of a system architecture; and
processing the combined representation to determine one of a plurality of mappings to use to map the second machine learning model to the system architecture.

2. The method of claim 1, wherein the second machine learning model is a large language model (LLM).

3. The method of claim 1, wherein the properties of the second machine learning model include one or more of:
a sparsity of the second machine learning model,
a data type of the second machine learning model,
a sequence length of the second machine learning model,
a number of layers of the second machine learning model,
a number of heads of the second machine learning model,
a dimensionality of hidden state vectors within an attention mechanism of the second machine learning model,
a dimensionality of a hidden layer within a Feed Forward Network (FFN) of the second machine learning model, or
a batch size configured for the second machine learning model.

4. The method of claim 1, wherein the properties of the system architecture include one or more of:
a central processing unit (CPU) type included in the system architecture,
a non-GPU accelerator included in the system architecture,
a graphics processing unit (GPU) type included in the system architecture,
a number of GPUs included in the system architecture,
a topology of the system architecture,
a communication network type included in the system architecture, or
an interconnect fabric type included in the system architecture.

5. The method of claim 1, wherein the system architecture includes a plurality of processors over which the second machine learning model is capable of being parallelized.

6. The method of claim 1, wherein the system architecture is a data center.

7. The method of claim 1, wherein the system architecture is one of:
a high-performance computing (HPC) cluster,
an artificial intelligence computing cluster, or
an edge device.

8. The method of claim 1, wherein the plurality of mappings include different possible parallelization schemes by which the second machine learning model can be parallelized on the system architecture.

9. The method of claim 8, wherein the different possible parallelization schemes include at least one of:
one or more data parallelization schemes, or
one or more model parallelization schemes.

10. The method of claim 1, wherein the plurality of mappings include different possible runtime frameworks for executing the second machine learning model on the system architecture.

11. The method of claim 1, wherein the combined representation is a single embedding of the properties of the second machine learning model and the properties of the system architecture.

12. The method of claim 1, wherein the combined representation of the properties of the second machine learning model and the properties of the system architecture is generated by:
concatenating the properties of the second machine learning model and the properties of the system architecture, and
learning, by the machine learning model, an embedding of the concatenated properties of the second machine learning model and properties of the system architecture.

13. The method of claim 1, wherein the plurality of mappings are predetermined and include all possible mappings between the second machine learning model and the system architecture.

14. The method of claim 1, wherein each mapping in the plurality of mappings is embedded in a shared representation space used to generate the combined representation of the properties of the second machine learning model and the properties of the system architecture.

15. The method of claim 14, wherein the one of the plurality of mappings to use to map the second machine learning model to the system architecture is determined as a result of its embedded representation being most closely aligned with the combined representation of the properties of the second machine learning model and the properties of the system architecture.

16. The method of claim 1, wherein the one of the plurality of mappings to use to map the second machine learning model to the system architecture is an optimal or near optimal mapping to use to map the second machine learning model to the system architecture among the plurality of mappings.

17. The method of claim 16, wherein the one of the plurality of mappings to use to map the second machine learning model to the system architecture is an optimal or near optimal mapping among the plurality of mappings in terms of performance corresponding to at least one of:
system tokens per second (TPS),
user TPS,
time to first token (TTFT),
latency, or
throughput.

18. The method of claim 16, wherein the one of the plurality of mappings to use to map the second machine learning model to the system architecture is the most optimal in terms of energy efficiency.

19. The method of claim 1, wherein the one of the plurality of mappings to use to map the second machine learning model to the system architecture is determined using a predefined metric.

20. The method of claim 19, wherein processing the combined representation includes generating a list ranking at least a subset of the plurality of mappings in accordance with the predefined metric, and wherein the one of the plurality of mappings to use to map the second machine learning model to the system architecture is determined as a top ranked mapping in the list.

21. The method of claim 20, wherein the predefined metric is a cosine similarity that is to be maximized or Euclidean distance that is to be minimized.

22. The method of claim 1, wherein the mapping is used to configure the system architecture to execute the second machine learning model.

23. The method of claim 1, wherein the machine learning model is trained to determine a mapping to use to map another machine learning model and system architecture given properties of the other machine learning model and properties of the system architecture.

24. The method of claim 23, wherein the machine learning model is trained using contrastive learning which includes:
minimizing a distance between similar embeddings of LLM/system architecture pairs and mappings, and
maximizing a distance between dissimilar embeddings of LLM/system architecture pairs and mappings.

25. The method of claim 24, wherein the distance is represented by a Euclidean distance.

26. The method of claim 24, wherein the distance is represented by a cosine similarity.

27. A system, comprising:
a non-transitory memory storage comprising instructions; and
one or more processors in communication with the memory, wherein the one or more processors execute the instructions to:
generate, by a machine learning model, a combined representation of properties of a second machine learning model and properties of a system architecture; and
process the combined representation to determine one of a plurality of mappings to use to map the second machine learning model to the system architecture.

28. A non-transitory computer-readable media storing computer instructions which when executed by one or more processors of a device cause the device to:
generate, by a machine learning model, a combined representation of properties of a second machine learning model and properties of a system architecture; and
process the combined representation to determine one of a plurality of mappings to use to map the second machine learning model to the system architecture.

29. A method, comprising:
at a device:
generating, by a first machine learning model, a combined representation of properties of a second machine learning model and properties of a system architecture;
processing the combined representation, by a generative machine learning model, to generate a mapping to use to map the second machine learning model to the system architecture.

30. The method of claim 29, wherein the generative machine learning model is a diffusion model.

31. The method of claim 29, wherein the generative machine learning model is an autoregressive model.

32. The method of claim 29, wherein the generative machine learning model is trained to generate a mapping to use to map another machine learning model and system architecture given properties of the other machine learning model and properties of the system architecture.

33. The method of claim 32, wherein the generative machine learning model is trained using guided generation.

34. The method of claim 32, wherein the generative machine learning model is trained using conditioned generation.

35. The method of claim 29, wherein the properties of the second machine learning model include one or more of:
a sparsity of the second machine learning model,
a data type of the second machine learning model,
a sequence length of the second machine learning model,
a number of layers of the second machine learning model,
a number of heads of the second machine learning model,
a dimensionality of hidden state vectors within an attention mechanism of the second machine learning model,
a dimensionality of a hidden layer within a Feed Forward Network (FFN) of the second machine learning model, or
a batch size configured for the second machine learning model.

36. The method of claim 29, wherein the properties of the system architecture include one or more of:
a central processing unit (CPU) type included in the system architecture,
a non-GPU accelerator included in the system architecture,
a graphics processing unit (GPU) type included in the system architecture,
a number of GPUs included in the system architecture,
a topology of the system architecture,
a communication network type included in the system architecture, or
an interconnect fabric type included in the system architecture.

37. The method of claim 29, wherein the mapping includes a parallelization scheme by which the second machine learning model can be parallelized on the system architecture.

38. The method of claim 37, wherein the parallelization schemes includes one of:
a data parallelization scheme, or
a model parallelization scheme.

39. The method of claim 29, wherein the mapping to use to map the second machine learning model to the system architecture is an optimal or near optimal mapping to use to map the second machine learning model to the system architecture in terms of performance or efficiency.

40. The method of claim 29, wherein the mapping is used to configure the system architecture to execute the second machine learning model.
